(19) United States
(12) Patent Application Publication
(10) Pub. No.: US 2002/0147987 A1
(43) Pub. Date: Oct. 10, 2002

(54) Video combiner

(76) Inventors: Steven Reynolds, Littleton, CO (US); Thomas Lemmons, Evergreen, CO (US)

Correspondence Address: The Law Offices of William W. Cochran, Suite 230, 3555 Stanford Road, Fort Collins, CO, 80525, US

(21) Appl. No.: 10/103,545

(22) Filed: Mar. 20, 2002

Related U.S. Application Data
(60) Provisional application No. 60/278,669, filed on Mar. 20, 2001.

(51) Int. Cl. G06F 3/00; H04N 5/445; G06F 13/00; H04N 7/173

(52) U.S. Cl. 725/110; 725/49

(57) ABSTRACT

Disclosed is a system that generates correlated video signals that are a combination of separate video signals that interrelate to each other in some fashion. The separate video signals are transmitted through a transmission channel to a viewer location. Separate video decoders decode the video signals at the viewer location. Presentation description instructions are also transmitted to the viewer location and are used to generate control signals to control the combination of the video signals at the viewer location.

### CROSS REFERENCE TO RELATED APPLICATIONS

This application is based upon and claims priority to U.S. provisional application No. 60/278,669 entitled “DELIVERY OF INTERACTIVE VIDEO CONTENT USING FULL MOTION VIDEO PLANES” filed Mar. 20, 2001 by Steve Reynolds and Tom Lemmons, the entire disclosure is specifically incorporated herein by reference for all that it discloses and teaches.

### BACKGROUND OF THE INVENTION

a. Field of the Invention

The present invention pertains generally to the generation of video signals and specifically to the generation of combined video signals.

b. Description of the Background

The process of combining video signals has been used in the past to generate unique combined video signals. For example, combined video signals have been used to combine foreground and background material in various ways, as well as other types of materials. Typically, this process is performed during production, such as in a production studio. The combined video signal generates a correlated image wherein the parts of the individual video signals are interrelated and used to create a unified, single picture, rather than two separate pictures that are displayed either simultaneously or separately.

There are many uses for combined or correlated video signals. For example, various combinations of individual video signals can be generated for viewing by different demographic groups to match the preferences of each group. In that regard, an automobile manufacturer may want to run a national advertisement. In the mountain states, it may be desirable to have depictions of mountains or skiing in the background. When the same advertisement is run in Florida, it may be preferable to have depictions of beaches and surf in the background. The demographics may be even more refined. For example, the preferences may vary on a viewer-by-viewer basis. However, for each combination, a separate combined video signal must be generated.

Combined video signals have other applications. It may be desirable to combine various interactive video feeds to produce a desired combined or correlated video signal for a particular viewer. Other applications of combined video signals include interactive games that can be combined as overlays with standard video feeds, advertising that can be combined with standard video feeds, or enhanced video feeds that can be combined in various fashions.

The problem that has existed in providing these combined video signals is that separate combined signals must be produced, usually at a studio production level. Each combined video signal must then be separately transmitted to the appropriate viewer. If there are a large number of different video feeds that are desired to be combined, this requires an exponentially larger number of combined video signals. For example, as the number of video feeds that are desired to be combined in various ways increases in a linear fashion, the number of combined video signals exponentially increases. The transmission channels for transmitting a large number of combined video signals may not be available, or may be very expensive to provide and maintain.

### SUMMARY OF THE INVENTION

The present invention overcomes the disadvantages and limitations of the prior art by providing a system that is capable of combining video signals at the viewer's location. For example, multiple video feeds can be provided to a viewer's set-top box together with instructions for combining two or more video feeds. The video feeds can then be combined in a set-top box or otherwise located at or near the viewer's location to generate the combined or correlated video signal for display.

Additionally, one or more video feeds can comprise enhanced video that is provided from an Internet connection. HTML-like scripting can be used to indicate the layout of the enhanced video signal. Instructions can be provided for replacement of individual pixels on a pixel by pixel basis. Further, presentation descriptions can be provided for combining HTML-like generated depictions with video signals.

The present invention may therefore comprise a method of locally generating a composite video signal at a viewer location comprising: generating a first video signal; generating a second video signal; generating a presentation description at a location that is remote from the viewer location; transmitting the presentation description to the viewer location; transmitting the first video signal and the second video signal as multiple video signals to the viewer location; generating control signals from the presentation description; and combining the multiple video signals in accordance with the control signals to produce a composite video signal, the composite video signal comprising a portion of the first video signal and a portion of the second video signal wherein the portion of the first video signal and the portion of the second video signal are displayed simultaneously.

The present invention may further comprise a method of creating customized composite video signal at a plurality of viewer locations comprising: creating a plurality of video signals; creating a plurality of presentation descriptions, each presentation description comprising instructions for combining a portion of at least one of the plurality of video signals with a portion of at least one other of the plurality of video signals; selecting a specific presentation description for each of a plurality of set top boxes; transmitting the specific presentation descriptions to each of set top boxes, the set top boxes located at a viewer location; creating control signals at each set top box based upon the specific presentation description; transmitting the plurality of video signals to the set top boxes; and creating a composite video image at each of the set top boxes based upon the control signals wherein a first portion of at least one of the plurality of video signals is merged with a second portion of at least one other of the plurality of video signals such that the first portion of the plurality of video signals and the second portion of the plurality of video signals are displayed simultaneously.

The present invention may further comprise a method of creating a correlated composite video image at a viewer location comprising: creating a first video image, a portion of the first image having specifically colored pixels; creating a second video image; transmitting the first image and the second image to a set top box at a viewer location; and creating a composite video image using the set top box wherein the specifically colored pixels of the first video are replaced with the corresponding pixels of the second video image.

The present invention may further comprise a method of creating customized correlated composite video images at a plurality of viewer's locations comprising: creating a first video image, a portion of the first image having specifically colored pixels; creating a plurality of secondary video images; creating a plurality of presentation descriptions, each presentation description comprising instructions for combining the first video image with at least a portion of the secondary video images; selecting a specific presentation description for each of a plurality of set top boxes; transmitting the presentation descriptions to the set top boxes, the set top boxes located at a viewer's location, transmitting the first image and the secondary images to the set top boxes; and creating a composite video image at each of the set top boxes wherein the specifically colored pixels of the first video are replaced with the corresponding pixels of at least a portion of at least one secondary video image wherein a portion of the first video images and a portion of the secondary video images are displayed simultaneously.

The present invention may further comprise a system for generating a composite video signal comprising: a first video signal; at least one additional video signal; a presentation description that describes the manner of combining the first video signal and the at least one additional video signal; a set top box adapted to receive the first video signal and the at least one additional video signal substantially simultaneously, the set top box having a video combiner that combines the first video signal and the at least one additional video signal in accordance with the presentation description to produce a composite video signal, wherein the composite video signal comprises a portion of the first video signal and a portion of the at least one additional video signal to be displayed substantially simultaneously.

The present invention may further comprise a system for generating a composite interactive video signal comprising: a first video signal, the first video signal being an interactive video signal; a second video signal; a presentation description that describes the manner of combining the first video signal and the second video signal; a transmission system capable of conveying the first video signal and the second video signal substantially simultaneously; and a set top box, the set top box being capable of receiving the video signals substantially simultaneously, the set top box being further capable of separating the first video signal, the second video signal, and the presentation description; the set top box being further capable of combining a portion of the first video signal and a portion of the second video signal to create a composite video signal wherein the portion of the first video signal and the portion of the second video signal are displayed simultaneously.

The present invention may further comprise a composite video advertisement on a television comprising: a first video signal, the first video signal being a broadcast signal received by a set top box; a second video signal, the second video signal being a broadcast signal received by the set top box at substantially the same time as the first video signal; a presentation description that is transmitted to the set top box; and a composite video advertisement, the composite video advertisement being a combination of a portion of the first video signal and a portion of the second video signal, the composite video advertisement being further combined in substantially real time by the set top box to produce the composite video advertisement wherein the portion of the first video signal and the portion of the second video signal are displayed simultaneously.

The present invention may further comprise a system for distributing and creating correlated video signals that are customized at each viewer's location comprising: a plurality of video signals; a plurality of presentation descriptions, each presentation description comprising instructions for combining a portion of at least one of the plurality of video signals with a portion of at least one other of the plurality of video signals; a selection method for determining which specific presentation description is to be used for each viewer; a transmission network for distributing each of the specific presentation descriptions to each view location; a transmission network for distributing the plurality of video signals to each viewer location; and a set top box located at each viewer location, the set top box adapted to receive the plurality of video signals and the presentation description, the set top box further adapted to create control signals based upon the specific presentation description, the set top box further adapted to create a composite video image based upon the control signals wherein a first portion of at least one of the plurality of video signals is merged with a second portion of at least one other of the plurality of video signals wherein the first portion of the plurality of video signals and the second portion of the plurality of video signals are displayed simultaneously.

The advantages of the present invention are that combined video signals can be generated at a viewer location upon receipt of individual video feeds and instructions for combining the video signals. In this fashion, the individual video feeds only need to be transmitted rather than each of the combined video signals. This decreases the bandwidth of the transmission link for transmitting the data since the individual video feeds are transmitted and combined in various ways at the viewer's location.

Further, one or more of the video feeds can be provided as an interactive video feed which allows the viewer to interact with the video using interactive television methodologies such as hot spots during the viewing of the video segments. This is accomplished by providing interactive video feeds that are combined at the viewer location, such as in the viewer set-top box.

### BRIEF DESCRIPTION OF THE DRAWINGS

In the drawings,

FIG. 1 is a schematic illustration of the overall system of the present invention;

FIG. 2 is a detailed block diagram of a set-top box, display, and remote control device of the system of the present invention.

FIG. 3 is an illustration of an embodiment of the present invention wherein four video signals may be combined into four composite video signals.

FIG. 4 is an illustration of an embodiment of the present invention wherein a main video image is combined with portions of a second video image to create five composite video signals.

### DETAILED DESCRIPTION OF THE PREFERRED EMBODIMENT OF THE INVENTION

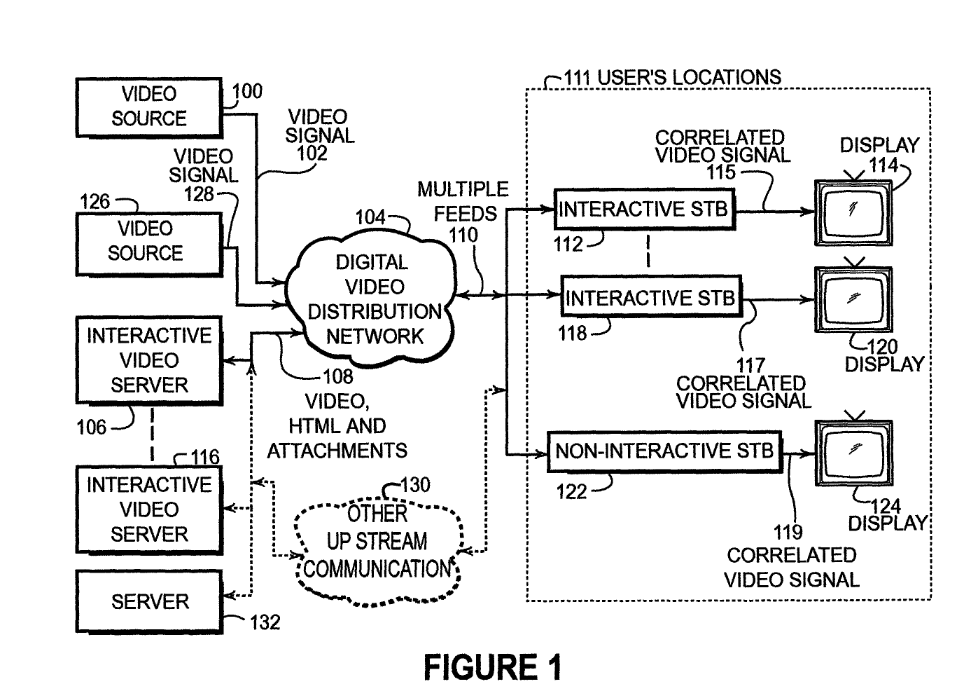

FIG. 1 illustrates the interconnections of the various components required to deliver a composite video signal to individual viewers. Video sources 100 and 126 send video signals 102 and 126 through a distribution network 104 to viewer's locations 111. Additionally, multiple interactive video servers 106 and 116 send video, HTML, and other attachments 108. The multiple feeds 110 are sent to several set top boxes 112, 118, and 122 connected to televisions 114, 120, and 124, respectively. The set top boxes 112 and 118 may be interactive set top boxes and set top box 122 may not have interactive features.

The video sources 100 and 126 and interactive video servers 106 and 116 may be attached to a conventional cable television head-end, a satellite distribution center, or other centralized distribution point for video signals. The distribution network 104 may comprise a cable television network, satellite television network, internet video distribution network, or any other network capable of distributing video data.

The interactive set top boxes 112 and 118 may communicate to the interactive video servers 106 and 108 though the video distribution network 104 if the video distribution network supports two-way communication, such as with cable modems. Additionally, communication may be through other upstream communication networks 130. Such upstream networks may include a dial up modem, direct internet connection, or other communication network that allows communication separate from the video distribution network 104.

Although FIG. 1 illustrates the use of interactive set-top boxes 112 and 118, the present invention can be implemented without an interactive connection with an interactive video server, such as interactive video servers 106 and 116. In that case, separate multiple video sources 100 can provide multiple video feeds 110 to non-interactive set-top box 122 at the viewer's locations 111. The difference between the interactive set top boxes 112 and 118 and the non-interactive set top box 122 is that the interactive set top boxes 112 and 118 incorporate the functionality to receive, format, and display interactive content and send interactive requests to the interactive video servers 106 and 116.

The set top boxes 112, 118, and 122 may receive and decode two or more video feeds and combine the feeds to produce a composite video signal that is displayed for the viewer. Such a composite video signal may be different for each viewer, since the video signals may be combined in several different manners. The manner in which the signals are combined is described in the presentation description. The presentation description may be provided through the interactive video servers 106 and 116 or through another server 132. Server 132 may be a web server or a specialized data server.

As disclosed below, the set-top box includes multiple video decoders and a video controller that provides control signals for combining the video signal that is displayed on the display 114. In accordance with currently available technology, the interactive set-top box 112 can provide requests to the interactive video server 106 to provide various web connections for display on the display 114. Multiple interactive video servers 116 can provide multiple signals to the viewer's locations 111.

The set top boxes 112, 118, and 122 may be a separate box that physically rests on top of a viewer's television set, may be incorporated into the television electronics, may be functions performed by a programmable computer, or may take on any other form.

The manner in which the video signals are to be combined is defined in the presentation description. The presentation description may be a separate file provided by the server 132, the interactive video servers 106 and 116, or may be embedded into one or more of the multiple feeds 110.

In some cases, the presentation description may be provided by the viewer directly into the set top box 112, 118, or 122. Such a presentation description may be viewer preferences stored in the set top box and created using menus, buttons on a remote, a graphical viewer interface, or any combination of the above. Other methods of creating a local presentation description may also be used.

The presentation description may take the form of a markup language wherein the format, look and feel of a video image is controlled. Using such a language, the manner in which two or more video images are combined may be fully defined. The language may be similar to HTML or other graphical mark up languages and allow certain video functions such as pixel by pixel replacement, rotation, translation, and deforming of portions of video images, the creation of text and other graphical elements, overlaying and ghosting of one video image with another, color key replacement of one video image with another, and any other command as may be contemplated.

Specific presentation descriptions may be created for each set top box and tailored to each viewer. For example, advertisements may be targeted at selected groups of viewers or a viewer may have preferences for certain look and feel of a television program. In some instances, some presentation descriptions may be applied to large groups of viewers.

The presentation descriptions may be transmitted from a server 132 to each set top box through a backchannel 130 or may be embedded into one or more of the video signals sent to the set top box. Further, the presentation descriptions may be sent individually to each set top box based on the address of the specific set top box. In some instances, the set top box may request a presentation description through the backchannel 130 or through the video distribution network 104. At that point, a server 132, interactive video server 106 or 116, or other source for a presentation description may send the requested presentation description to the set top box.

Interactive content supplied by interactive video server 106 or 116 may include the instructions for a set top box to request the presentation description from a server through a backchannel. A methodology for transmitting and receiving this data is described in U.S. Provisional Patent Application entitled “Multicasting of Interactive Data Over A Back Channel”, filed Mar. 5, 2002 by Ian Zenoni, which is specifically incorporated herein by reference for all it discloses and teaches.

The presentation description may contain the commands necessary for several combinations of video. In such a case, the local preferences of the viewer, stored in the set top box, may indicate which set of commands would be used to display the specific combination of video suitable for that viewer. For example, in an advertisement campaign, a presentation description may include commands for combining several video images for four different commercials for four different products. The viewer's preferences located inside the set top box may indicate a preference for the first commercial, thusly the commands required to combine the video signals to produce the first commercial will be executed and the other three sets of commands will be ignored.

In operation, the device of FIG. 1 provides multiple video feeds 110 to the viewer's locations 111. The multiple video feeds are combined by each of the interactive set-top boxes 112, 118, 122 to generate correlated or composite video signals 115, 117, 119, respectively. As disclosed below, each of the interactive set-top boxes 112, 118, 122 uses instructions provided by the video source 100, interactive video servers 106, 116, a separate server 132, or viewer preferences stored at the viewer's location to generate control signals to combine the signals into a correlated video signal. Additionally, presentation description information provided by each of the interactive video servers 106, 116 can provide layout descriptions for displaying a video attachment. The correlated video signal may overlay the various video feeds on a full screen basis, or on portions of the screen display. In any event, the various video feeds may interrelate to each other in some fashion such that the displayed signal is a correlated video signal with interrelated parts provided by each of the separate video feeds.

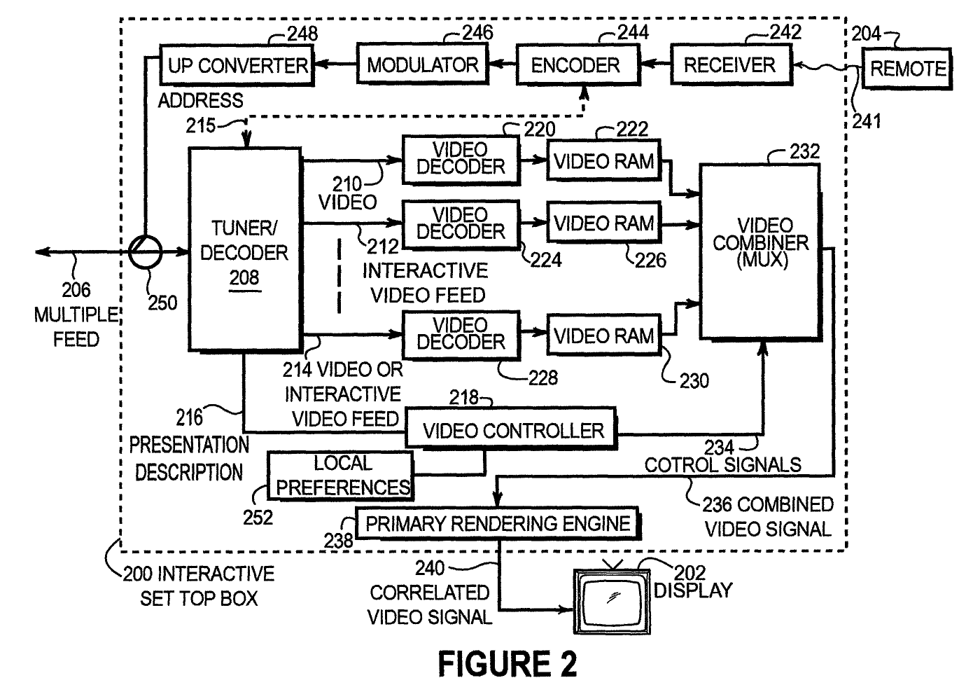

FIG. 2 is a detailed schematic block diagram of an interactive set-top box together with a display 202 and remote control device 204. As shown in FIG. 2, a multiple video feed signal 206 is supplied to the interactive set-top box 200. The multiple video feed signal 206 that includes a video signal, HTML signals, video attachments, a presentation description, and other information is applied to a tuner/decoder 208. The tuner/decoder 208 extracts each of the different signals such as a video MPEG signal 210, an interactive video feed 212, another video or interactive video feed 214, and the presentation description information 216.

The presentation description information 216 is the information necessary for the video combiner 232 to correctly combine the various portions of multiple video signals to form a composite video image. The presentation description information 216 can take many forms, such as an ATVEF trigger or a markup language description using HTML or a similar format. Such information may be transmitted in a vertical blanking encoded signal that includes instructions as to the manner in which to combine the various video signals. For example, the presentation description may be encoded in the vertical blanking interval (VBI) of stream 210. The presentation description may also include Internet addresses for connecting to enhanced video web sites. The presentation description information 216 may include specialized commands applicable to specialized set top boxes, or may contain generic commands that are applicable to a wide range of set top boxes. References made herein to the ATVEF specification are made for illustrative purposes only, and such references should not be construed as an endorsement, in any manner, of the ATVEF specification.

The presentation description information 216 may be a program that is embedded into one or more of the video signals in the multiple feed 206. In some cases, the presentation description information 216 may be sent to the set top box in a separate channel or communication format that is unrelated to the video signals being used to form the composite video image. For example, the presentation description information 216 may come through a direct internet connection made through a cable modem, a dial up internet access, a specialized data channel carried in the multiple feed 206, or any other communication method.

As also shown in FIG. 2, the video signal 210 is applied to a video decoder 220 to decode the video signal and apply the digital video signal to video RAM 222 for temporary storage. The video signal 210 may be in the MPEG standard, wherein predictive and intracoded frames comprise the digitized video signal. Other video standards may be used for the storage and transmission of the video signal 210 while maintaining within the spirit and intent of the present invention. Similarly, video decoder 224 receives the interactive video feed 212 that may comprise a video attachment from an interactive web page. The video decoder 224 decodes the video signal and applies it to a video RAM 226. Video decoder 228 is connected to video RAM 230 and operates in the same fashion. The video decoders 220, 224, 228 may also perform decompression functions to decompress MPEG or other compressed video signals. Each of the video signals from video RAMs 222, 226, 230 is applied to a video combiner 232. Video combiner 232 may comprise a multiplexer or other device for combining the video signals. The video combiner 232 operates under the control of control signals 234 that are generated by the video controller 218.

The video controller 218 receives the presentation description instructions 216 and generates the control signals 234 to control the video combiner 232. The control signals may include many commands to merge one video image with another. Such commands may include direct overlay of one image with another, pixel by pixel replacement, color keyed replacement, the translation, rotation, or other movement of a section of video, ghosting of one image over another, or any other manipulation of one image and combination with another as one might desire. For example, the presentation description instructions 216 may indicate that the video signal 210 be displayed on full screen while the interactive video feed 212 only be displayed on the top third portion of the screen.

The presentation description instructions 216 also instruct the video controller 218 as to how to display the pixel information. For example, the control signals 234 generated by the video controller 218 may replace the background video pixels of video 210 in the areas where the interactive video feed 212 is applied on the top portion of the display. The presentation description instructions 216 may set limits as to replacement of pixels based on color, intensity, or other factors. Pixels can also be displayed based upon the combined output of each of the video signals at any particular pixel location to provide a truly combined output signal. Of course, any desired type of combination of the video signals can be obtained, as desired, to produce the combined video signal 236 at the output of the video combiner 232. Also, any number of video signals can be combined by the video combiner 232 as illustrated in FIG. 2. It is only necessary that a presentation description 216 be provided so that the video controller 218 can generate the control signals 234 that instruct the video combiner 232 to properly combine the various video signals.

The presentation description instructions 216 may be instructions sent from a server directly to the set top box 200 or the presentation description instructions 216 may be settable by the viewer. For example, if an advertisement were to be shown to a specific geographical area, such as to the viewers in a certain zip code, a set of presentation description instructions 216 maybe embedded into the advertisement video instructing the set top box 200 to combine the video in a certain manner.

In some embodiments, the viewer's preferences may be stored in the local preferences 252 and used either alone or in conjunction with the presentation description instructions 216. For example, the local preferences may be to merge a certain preferred background with a news show. In another example, the viewer's local preferences may select from a list of several options presented in the presentation description information 216. In such an example, the presentation description information 216 may contain the instructions for several alternative presentation schemes, one of which may be preferred by a viewer and contained in the local preferences 252.

In some embodiments, the viewer's preferences may be stored in a central server. Such an embodiment may provide for the collection and analysis of statistics regarding viewer preferences. Further, customized and targeted advertisements and programming preferences may be sent directly to the viewer, based on their preferences analyzed on a central server. The server may have the capacity to download presentation description instructions 216 directly to the viewer's set top box. Such a download may be pushed, wherein the server sends the presentation description instructions 216, or pulled, wherein the set top box requests the presentation description instructions 216 from the server.

As also shown in FIG. 2, the combined video signal 236 is applied to a primary rendering engine 238. The primary rendering engine 238 generates the correlated video signal 240. The primary rendering engine 238 formats the digital combined video signal 236 to produce the correlated video signal 240. If the display 202 is an analog display, the primary rendering engine 238 also performs functions as a digital-to-analog converter. If the display 202 is a high definition digital display, the primary rendering engine 238 places the bits in the proper format in the correlated video signal 240 for display on the digital display.

FIG. 2 also discloses a remote control device 204 under the operation of a viewer. The remote control device 204 operates in the standard fashion in which remote control devices interact with interactive set-top boxes, such as interactive set-top box 200. The set-top box includes a receiver 242 such as an infrared (IR) receiver that receives the signal 241 from the remote 204. The receiver 242 transforms the IR signal into an electrical signal that is applied to an encoder 244. The encoder 244 encodes the signal into the proper format for transmission as an interactive signal over the digital video distribution network 104 (FIG. 1). The signal is modulated by modulator 246 and up-converted by up-converter 248 to the proper frequency. The up-converted signal is then applied to a directional coupler 250 for transmission on the multiple feed 206 to the digital video distribution network 104. Other methods of interacting with an interactive set top box may be also employed. For example, viewer input may come through a keyboard, mouse, joystick, or other pointing or selecting device. Further, other forms of input, including audio and video may be used. The example of the remote control 204 is exemplary and not intended to limit the invention.

As also shown in FIG. 2, the tuner/decoder 208 may detect web address information 215 that may be encoded in the video signal 102 (FIG. 1). This web address information may contain information as to one or more web sites that contain presentation descriptions that interrelates to the video signal 102 and that can be used to provide the correlated video signal 240. The decoder 208 detects the address information 215 which may be encoded in any one of several different ways such as an ATVEF trigger, as a tag in the vertical blanking interval (VBI), encoded in the back channel, embedded as a data PID (program identification) signal in a MPEG stream, or other encoding and transmitting method. The information can also be encoded in streaming media in accordance with Microsoft's ASF format. Encoding this information as an indicator is more fully disclosed in U.S. patent application Ser. No. 10/076,950, filed Feb. 12, 2002 entitled “Video Tags and Markers,” which is specifically incorporated herein by reference for all that it discloses and teaches. The manner in which the tuner/decoder 208 can extract the one or more web addresses 215 is more fully disclosed in the above referenced patent application. In any event, the address information 215 is applied to the encoder 244 and is encoded for transmission through the digital video distribution network 104 to an interactive video server. The signal is modulated by modulator 246 and up-converted by up-converter 248 for transmission to the directional coupler 250 over the cable. In this fashion, video feeds can automatically be provided by the video source 100 via the video signal 102.

The web address information that is provided can be selected, as referenced above, by the viewer activating the remote control device 204. The remote control device 204 can comprise a personalized remote, such as disclosed in U.S. patent application Ser. No. 09/941,148, filed Aug. 27, 2001 entitled “Personalized Remote Control,” which is specifically incorporated by reference for all that it discloses and teaches. Additionally, interactivity using the remote 204 can be provided in accordance with U.S. patent application Ser. No. 10/041,881, filed Oct. 24, 2001 entitled “Creating On-Content Enhancements,” which is specifically incorporated herein by reference for all that it discloses and teaches. In other words, the remote 204 can be used to access “hot spots” on any one of the interactive video feeds to provide further interactivity, such as the ability to order products and services, and other uses of the “hot spots” as disclosed in the above referenced patent application. Preference data can also be provided in an automated fashion based upon viewer preferences that have been learned by the system or are selected in a manual fashion using the remote control device in accordance with U.S. patent application Ser. No. 09/933,928, filed Aug. 21, 2001, entitled “iSelect Video” and U.S. patent application Ser. No. 10/080,996, filed Feb. 20, 2002 entitled “Content Based Video Selection,” both of which are specifically incorporated by reference for all that they disclose and teach. In this fashion, automated or manually selected preferences can be provided to generate the correlated video signal 240.

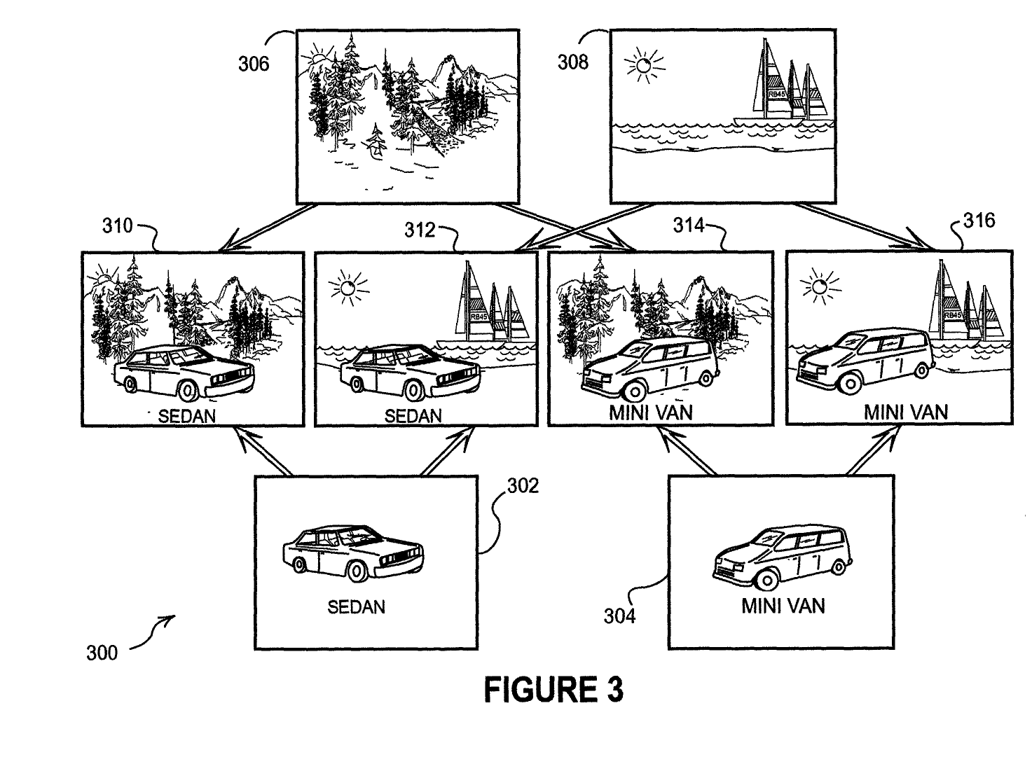

FIG. 3 illustrates an embodiment 300 of the present invention wherein four video signals, 302, 304, 306, and 308, may be combined into four composite video signals 310, 312, 314, and 316. The video signals 302 and 304 represent advertisements for two different vehicles. Video signal 302 shows an advertisement for a sedan model car, where video signal 304 shows an advertisement for a minivan. The video signals 306 and 308 are background images, where video signal 306 shows a background for a mountain scene and video signal 308 shows a background for an ocean scene. The combination or composite of video signals 306 and 302 yields signal 310, showing the sedan in front of a mountain scene. Similarly, the signals 312, 314, and 316 are composite video signals.

In the present embodiment, the selection of which composite image to display on a viewer's television may be made in part with a local preference for the viewer and by the advertiser. For example, the advertiser may wish to show a mountain scene to those viewers fortunate enough to live in the mountain states. The local preferences may dictate which car advertisement is selected. In the example, the local preferences may determine that the viewer is an elderly couple with no children at home and thus may prefer to see an advertisement for a sedan rather than a minivan.

The methodology for combining the various video streams in the present embodiment may be color key replacement. Color key replacement is a method of selecting pixels that have a specific color and location and replacing those pixels with the pixels of the same location from another video image. Color key replacement is a common technique used in the industry for merging two video images.

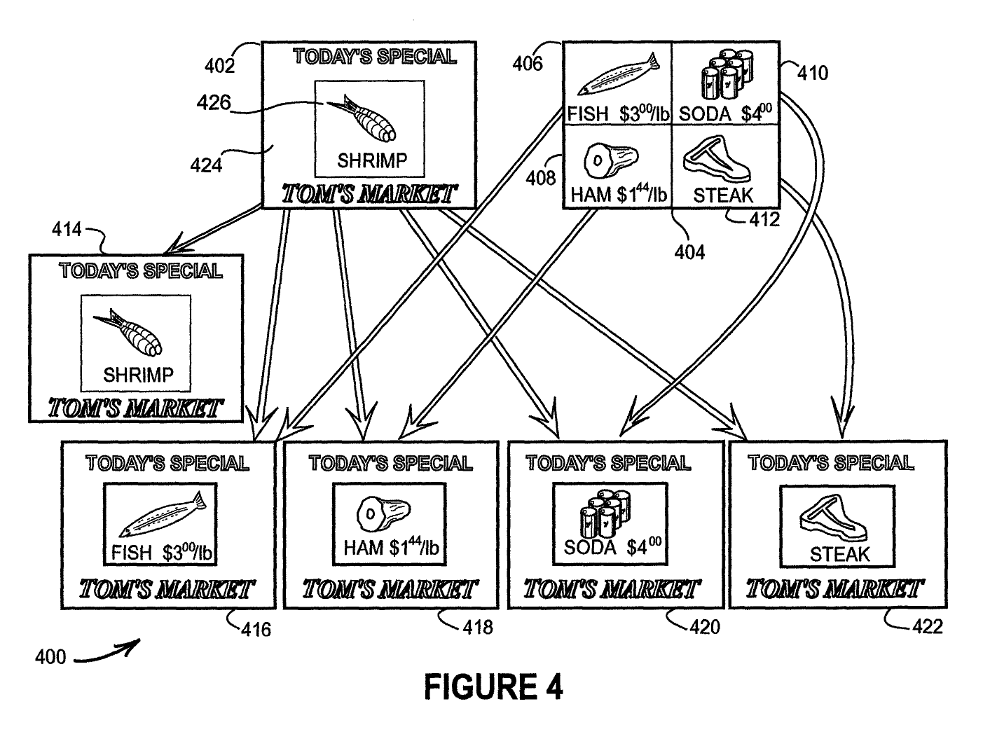

FIG. 4 illustrates an embodiment 400 of the present invention wherein a main video image 402 is combined with portions of a second video image 404. The second video image 404 comprises four small video images 406, 408, 410, and 412. The small images may be inserted into the main video image 402 to produce several composite video images 414, 416, 418, 420, and 422.

In the embodiment 400, the main video image 402 comprises a border 424 and a center advertisement 426. In this case, the border describes today's special for Tom's Market. The special is the center advertisement 426, which is shrimp. Other special items are shown in the second video image 404, such as fish 406, ham 408, soda 410, and steak 412. The viewer preferences may dictate which composite video is shown to a specific viewer. For example, if the viewer were vegetarian, neither the ham 408 nor steak 412 advertisements would be appropriate. If the person had a religious preference that indicated that they would eat fish on a specific day of the week, for example, the fish special 406 may be offered. If the viewer's preferences indicated that the viewer had purchased soda from the advertised store in the past, the soda advertisement 410 may be shown. In cases where no preference is shown, a random selection may be made by the set top box, a default advertisement, or other method for selecting an advertisement may be used.

Hence, the present invention provides a system in which a correlated or composite video signal can be generated at the viewer location. An advantage of such a system is that multiple video feeds can be provided and combined as desired at the viewer's location. This eliminates the need for generating separate combined video signals at a production level and transmission of those separate combined video signals over a transmission link. For example, if ten separate video feeds are provided over the transmission link, a total of ten factorial combined signals can be generated at the viewer's locations. This greatly reduces the number of signals that have to be transmitted over the transmission link.

Further, the present invention provides for interactivity in both an automated, semi-automated, and manual manner by providing interactive video feeds to the viewer location. As such, greater flexibility can be provided for generating a correlated video signal.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of locally generating a composite video signal at a viewer location comprising:
generating a first video signal;
generating a second video signal;
generating a presentation description at a location that is remote from the viewer location;
transmitting said presentation description to said viewer location;
transmitting said first video signal and said second video signal as multiple video signals to said viewer location;
generating control signals from said presentation description; and
combining said multiple video signals in accordance with said control signals to produce a composite video signal, said composite video signal comprising a portion of said first video signal and a portion of said second video signal wherein said portion of said first video signal and said portion of said second video signal are displayed simultaneously.

2. The method of claim 1 wherein the composite video signal generates a correlated image.

3. The method of claim 1 wherein said step of generating control signals is performed by a set top box.

4. The method of claim 1 wherein said step of combining the multiple video signals is performed by a set top box.

5. The method of claim 1 wherein said presentation description is transmitted as part of said first video signal.

6. The method of claim 1 further comprising transmitting said first video signal and second video signal substantially simultaneously.

7. A method of creating customized composite video signal at a plurality of viewer locations comprising:
creating a plurality of video signals;
creating a plurality of presentation descriptions, each presentation description comprising instructions for combining a portion of at least one of said plurality of video signals with a portion of at least one other of said plurality of video signals;
selecting a specific presentation description for each of a plurality of set top boxes;
transmitting said specific presentation descriptions to each of set top boxes, said set top boxes located at a viewer location;
creating control signals at each set top box based upon said specific presentation description;
transmitting said plurality of video signals to said set top boxes; and
creating a composite video image at each of said set top boxes based upon said control signals wherein a first portion of at least one of said plurality of video signals is merged with a second portion of at least one other of said plurality of video signals such that said first portion of said plurality of video signals and said second portion of said plurality of video signals are displayed simultaneously.

8. The method of claim 7 wherein said step of transmitting said plurality of video signals is done substantially simultaneously.

9. The method of claim 7 wherein said presentation descriptions are embedded into at least one of said video signals.

10. A method of generating an interactive video signal at a viewer location comprising:
generating a first video signal;
generating a second video signal, said second video signal including interactive content;
generating a presentation description;
transmitting said presentation description to a viewer location;
transmitting said first video signal and said second video signal as multiple video signals to said viewer location;
generating control signals from said presentation description; and
combining said multiple video signals in accordance with said control signals to produce a composite video signal, said composite video signal comprising a portion of said first video signal and a portion of said second video signal wherein said portion of said first video signal and said portion of said second video signal are displayed simultaneously.

11. The method of claim 10 wherein said step of separating said video signals is performed by a set top box.

12. The method of claim 10 wherein said step of generating control signals is performed by a set top box.

13. The method of claim 10 wherein said step of combining the multiple video signals is performed by a set top box.

14. The method of claim 10 wherein said presentation description is transmitted as part of said first video signal.

15. The method of claim 10 wherein said presentation description is transmitted as part of said second video signal.

16. The method of claim 10 further comprising transmitting said first video signal and said second video signal substantially simultaneously.

17. A method of creating a correlated composite video image at a viewer location comprising:
creating a first video image, a portion of said first image having specifically colored pixels;
creating a second video image;
transmitting said first image and said second image to a set top box at a viewer location; and
creating a composite video image using said set top box wherein said specifically colored pixels of said first video are replaced with the corresponding pixels of said second video image.

18. A method of creating customized correlated composite video images at a plurality of viewer's locations comprising:
creating a first video image, a portion of said first image having specifically colored pixels;
creating a plurality of secondary video images;
creating a plurality of presentation descriptions, each presentation description comprising instructions for combining said first video image with at least a portion of said secondary video images;
selecting a specific presentation description for each of a plurality of set top boxes;
transmitting said presentation descriptions to said set top boxes, said set top boxes located at a viewer's location,
transmitting said first image and said secondary images to said set top boxes; and
creating a composite video image at each of said set top boxes wherein said specifically colored pixels of said first video are replaced with the corresponding pixels of at least a portion of at least one secondary video image wherein a portion of said first video images and a portion of said secondary video images are displayed simultaneously.

19. A system for generating a composite video signal comprising:
a first video signal;
at least one additional video signal;
a presentation description that describes the manner of combining said first video signal and said at least one additional video signal;
a set top box adapted to receive said first video signal and said at least one additional video signal substantially simultaneously, said set top box having a video combiner that combines said first video signal and said at least one additional video signal in accordance with said presentation description to produce a composite video signal, wherein said composite video signal comprises a portion of said first video signal and a portion of said at least one additional video signal to be displayed substantially simultaneously.

20. A system for generating a composite interactive video signal comprising:
a first video signal, said first video signal being an interactive video signal;
a second video signal;
a presentation description that describes the manner of combining said first video signal and said second video signal;
a transmission system capable of conveying said first video signal and said second video signal substantially simultaneously; and
a set top box, said set top box being capable of receiving said video signals substantially simultaneously, said set top box being further capable of separating said first video signal, said second video signal, and said presentation description; said set top box being further capable of combining a portion of said first video signal and a portion of said second video signal to create a composite video signal wherein said portion of said first video signal and said portion of said second video signal are displayed simultaneously.

21. The system of claim 20 wherein said presentation description is embedded into said first video signal.

22. The system of claim 20 wherein said presentation description is embedded into said second video signal.

23. A composite video advertisement on a television comprising:
a first video signal, said first video signal being a broadcast signal received by a set top box;
a second video signal, said second video signal being a broadcast signal received by said set top box at substantially the same time as said first video signal;
a presentation description that is transmitted to said set top box; and
a composite video advertisement, said composite video advertisement being a combination of a portion of said first video signal and a portion of said second video signal, said composite video advertisement being further combined in substantially real time by said set top box to produce said composite video advertisement wherein said portion of said first video signal and said portion of said second video signal are displayed simultaneously.

24. The advertisement of claim 23 wherein said presentation description is embedded into said first video signal.

25. A system for distributing and creating correlated video signals that are customized at each viewer's location comprising:
a plurality of video signals;
a plurality of presentation descriptions, each presentation description comprising instructions for combining a portion of at least one of said plurality of video signals with a portion of at least one other of said plurality of video signals;
a selection method for determining which specific presentation description is to be used for each viewer;
a transmission network for distributing each of said specific presentation descriptions to each view location;
a transmission network for distributing said plurality of video signals to each viewer location; and
a set top box located at each viewer location, said set top box adapted to receive said plurality of video signals and said presentation description, said set top box further adapted to create control signals based upon said specific presentation description, said set top box further adapted to create a composite video image based upon said control signals wherein a first portion of at least one of said plurality of video signals is merged with a second portion of at least one other of said plurality of video signals wherein said first portion of said plurality of video signals and said second portion of said plurality of video signals are displayed simultaneously.

26. The method of claim 25 wherein said step of transmitting said plurality of video signals is done substantially simultaneously.

27. The method of claim 25 wherein said presentation descriptions are embedded into at least one of said video signals.

28. The method of claim 25 wherein said selection method comprises a personalized remote.

29. The method of claim 25 wherein said selection method comprises stored preferences in said set top box.
